(19) United States
(12) Patent Application Publication
(10) Pub. No.: US 2016/0045398 A1
(43) Pub. Date: Feb. 18, 2016

(54) ELECTRONIC MEDICINE CONTAINING DEVICE, SYSTEM FOR DISPENSING MEDICINES AND METHOD THEREOF

(71) Applicant: ADVANTECH CO., LTD., TAIPEI (TW)

(72) Inventors: RONG-PIN LAI, NEW TAIPEI CITY (TW); CHUAN-TZUO SUN, TAIPEI CITY (TW); CHIH-HUI WANG, TAIPEI CITY (TW); BO-FENG SU, NEW TAIPEI CITY (TW); FONG JUNG CHAN, TAIPEI CITY (TW); CHI-CHIEN HSU, TAIPEI CITY (TW); TSUNG-TSO KAN, TAIPEI CITY (TW); CHE-HSIUNG WANG, NEW TAIPEI CITY (TW); CHUN-JU WU, NEW TAIPEI CITY (TW)

(21) Appl. No.: 14/580,343

(22) Filed: Dec. 23, 2014

(30) Foreign Application Priority Data
Aug. 13, 2014 (TW) 103127759

(51) Int. Cl. A61J 7/04; G07F 17/00

(52) U.S. Cl. CPC A61J 7/0454; G07F 17/0092

(57) ABSTRACT

An electronic medicine containing device, system for dispensing medicines and method thereof are provided. The electronic medicine containing device includes a housing, an antenna module, a processing unit, and a prompting unit. The housing is configured for placing one or more containers. The antenna module includes multiple antenna ports, each antenna port is connected to an antenna, and each antenna is configured on an antenna position in the housing for reading a corresponding tag on the container. The processing unit coupled to the antenna module is configured to receive a tag data and process a query message of the electronic medicine containing device. The prompting unit coupled to the processing unit is used for showing a result generated by the electronic medicine containing device based on the query message.

### BACKGROUND

1. Technical Field

The present disclosure relates to a medicine containing device and a system for dispensing medicines and method thereof, more particularly to an electronic medicine containing device, system for dispensing medicines and method thereof.

2. Description of Related Art

RFID technology has become a very important item in current science and technology fields. Apart from security management, applications in physical distribution industries and selling stock, RFID has further been recently applied to electronic consumption according to consumers' consumption habits and information security software development. RFID technology is a wireless radio frequency object identification technology, and its basic structure is formed by integrating a reader, a tag and a software system. The RFID can be applied to different reading frequencies, such as low frequency (LF), high frequency (HF), very high frequency (VHF), ultra high frequency (UHF) and super high frequency (SHF), and each of frequency bands supports a different sensing distance using the applied frequency. Currently, the frequency band assigned for use already is UHF which supports the sensing distance larger than 1.5 meter, so the wireless radio frequency object identification technology can further be applied in vehicle management systems to provide a lot of convenience.

However, during the process of applying the wireless radio frequency object identification technology, most tag data are written fixedly before the company provides the service, and the reader usually reads the message written in the tag in advance and then provides the message to a background system for registering dynamical information, such as visiting or not, passing or not, consuming or not, registering or not, which is provided to the system end for simple message recording. In addition, when the user utilizes the wireless radio frequency object identification technology in the application of data management, it is hard for the current simple tag message and the fixed structure in the current technology to provide a more complicated and more flexible service.

### SUMMARY

An exemplary embodiment of the present disclosure illustrates an electronic medicine containing device, system for dispensing medicines and method thereof, to provide a method of automatically switching antenna ports to search tag data and generate a prompt, so requisite time for the personnel to search physical data or for a physical object can be reduced and the management efficiency can be improved.

An embodiment of the present disclosure provides an electronic medicine containing device. The electronic medicine containing device includes a housing, an antenna module, a processing unit, and a prompting unit. The housing is configured for placing one or more containers. The antenna module includes multiple antenna ports, each antenna port is connected to an antenna, and each of antennas is configured on an antenna position in the housing for reading a tag on the container. The processing unit is coupled to the antenna module and configured for receiving tag data gotten by the antenna module and processing a query message of the electronic medicine containing device. The prompting unit is coupled to the processing unit and configured for indicating a result generated by the electronic medicine containing device.

An embodiment of the present disclosure provides a system for dispensing medicines, and the system includes a data server and at least one electronic medicine containing device which is linked with the data server via a communication unit. The electronic medicine containing device includes a housing, an antenna module, a prompting unit, and a processing unit. The housing is configured for placing one or more containers. The antenna module includes multiple antenna ports, each antenna port is connected to an antenna, and each of antennas is configured for reading a tag on the container. The processing unit is coupled to the antenna module, and configured for receiving tag data gotten by the antenna module and processing a query message of the electronic medicine containing device. The prompting unit is coupled to the processing unit, and configured for indicating a result generated by the electronic medicine containing device based on the query message.

Another embodiment of the present disclosure provides a method for dispensing medicines, adapted for the system for dispensing medicines. The system for dispensing medicines includes a data server and at least one electronic medicine containing device. The method includes a write-in procedure and a read procedure. The read procedure includes the following steps. Firstly, multiple tag data are gotten from the data server via a communication unit in the electronic medicine containing device. Next, a query message is compared with the tag data read by the antenna of the electronic medicine containing device. When the tag data is determined to match with the query message, a prompting unit of the electronic medicine containing device sends a prompt signal indicating an antenna position of the antenna.

In summary, the electronic medicine containing device, system for dispensing medicines and method thereof according to the embodiment of the present disclosure provide an approach to switch the antenna ports, one by one, to compare whether or not the tag data matches with the query message. The prompt signal indicating the antenna position can be provided. Therefore, by the embodiments of the present disclosure, the invention achieves the technical effect of saving time for searching the tag.

In order to further understand the techniques, means and effects of the present disclosure, the following detailed descriptions and appended drawings are hereby referred, such that, through which, the purposes, features and aspects of the present disclosure can be thoroughly and concretely appreciated; however, the appended drawings are merely provided for reference and illustration, without any intention to be used for limiting the present disclosure.

### BRIEF DESCRIPTION OF THE DRAWINGS

The accompanying drawings are included to provide a further understanding of the present disclosure, and are incorporated in and constitute a part of this specification. The drawings illustrate exemplary embodiments of the present disclosure and, together with the description, serve to explain the principles of the present disclosure.

FIG. 1 is a schematic view of an embodiment of an electronic medicine containing device according to the present disclosure.

FIG. 2 is a function block view of an embodiment of the electronic medicine containing device according to the present disclosure.

FIG. 3 is a schematic view of another embodiment of the electronic medicine containing device according to the present disclosure.

FIG. 4 is a function block view of an embodiment of the electronic medicine containing device according to the present disclosure.

FIG. 5 is a schematic view of the system environment of an embodiment of a system for dispensing medicines according to the present disclosure.

FIG. 6 is a schematic view of content of a tag database of an embodiment according to the present disclosure.

FIG. 7 and FIG. 8 are flow views of an embodiment of method of dispensing medicines according to the present disclosure.

### DESCRIPTION OF THE EXEMPLARY EMBODIMENTS

Reference will now be made in detail to the exemplary embodiments of the present disclosure, examples of which are illustrated in the accompanying drawings. Wherever possible, the same reference numbers are used in the drawings and the description to refer to the same or like parts.

### First Embodiment of the Electronic Medicine Containing Device

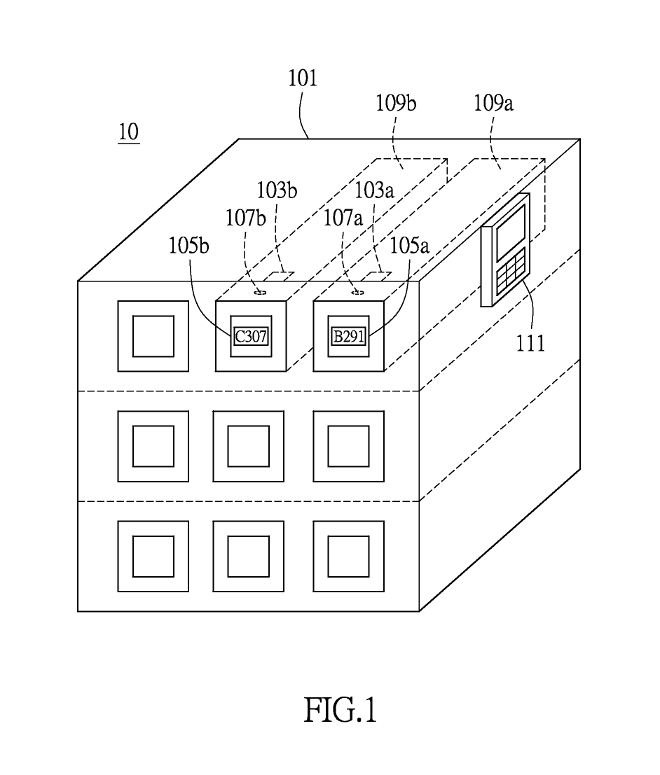

FIG. 1 is a schematic view of an embodiment of an electronic medicine containing device according to the present disclosure. Please refer to FIG. 1. In an embodiment, the electronic medicine containing device 10 includes a housing 101, multiple antennas (not shown in FIG. 1) configured on antenna positions 103a and 103b, and prompting units 107a and 107b. Containers 109a and 109b are placed in the housing 101, and tags 105a and 105b are attached on the containers 109a and 109b, respectively. The containers 109a and 109b are configured for placing various objects, such as medicines for an ill person.

In this example, the housing 101 can be a containing case, and the containers 109a and 109b, such as containing boxes, can be appropriately arranged in the containing case. The tags 105a and 105b, such as an RFID tag or NFC tag, can be arranged on positions corresponding to the containers 109a and 109b. As shown in FIG. 1, the tag 105a of this embodiment is attached at a side of the container 109a, and the tag 105b is attached at a side of the container 109b, and the sides can be labeled letter selectively to enable the user to review easily For example, a tag 105a labeled letter “B291” and a tag 105b labeled letter “C307” are exemplified. The letter labeled on the tag can be changed upon condition of actual use The approach allows the user to obtain brief information such as property or content of the corresponding container from the labeled letter. The example shows the ill persons' names are labeled by the tags 105a and 105b associated with the containers 109a and 109b where the medicines for the ill persons are contained.

The antennas (not shown in FIG. 1) of the electronic medicine containing device 10 are disposed at the antenna positions 103a and 103b inside or on the housing 101, respectively. For example, the antenna position 103a is located within the range allowing the tag 105a to be readable, and the antenna position 103b within the range is also for the tag 105b to be readable. In this exemplary embodiment, the antenna at the antenna position 103a can just read tag 105a, and the antenna at the antenna position 103b can just read tag 105b. During the operation, the antennas are used to correspondingly read the tags 105a and 105b, by turns, to achieve the purpose of searching the containers 109a and 109b. The further detail of process is illustrated in the following paragraphs. It is worth mentioning that the embodiment is not limited to the one by one corresponding relationship between antennas and tags, and the user can configure multiple antennas in an antenna position according to practical conditions to implement the present disclosure.

The prompting units 107a and 107b are configured at the positions corresponding to the antenna positions 103a and 103b, respectively, as shown in FIG. 1. The prompting units 107a and 107b, such as indicator, display panel or audio output device, are configured for sending prompt signals for prompting the antenna positions 103a and 103b. The user is notified where the antenna position is which should be noted via the prompt signal in the manner of indicating a light signal, displaying letter or outputting a sound message.

In another embodiment, the electronic medicine containing device 10 further includes a query input unit 111 which is selectively configured on a side of the housing 101 or wiredly connected to a circuit board port (not shown in FIG. 1) of the electronic medicine containing device 10. The query input unit 111 is used to provide the user to input a query message, such as the letter labeled on the tag or message related to the tag. The query input unit 111 can include a display screen and an input keyboard for providing corresponding functions of inputting letter and displaying the query message.

For example, the electronic medicine containing device 101 exemplarily has nine containers as shown in FIG. 1. In order to save time for the user in searching the container in the case of the tags not labeled by letter, or labeled by the letter not associated with the object, or the labeled letter not having a readable meaning, the user gets the objects contained in the electronic medicine containing device 10 and the user can input the query message via the query input unit 111. The electronic medicine containing device 101 then compares the query message with the tag data read by each of antennas one by one. For example, the electronic medicine containing device 101 determines whether or not the data read by the antenna at the antenna position 103b from the tag 105b matches with the query message. The prompting unit 107b corresponding to the antenna position 103b sends the prompt signal accordingly. The prompt signal indicates the antenna position of the antenna which reads the tag matching with the query message. By being reminded of the antenna position and the corresponding relationship between the tag and the container via the prompt signal, the user can obtain the position of the container where the target objects are contained. For example, the nurse can be made aware that the medicine for the queried ill person is placed in the container 109b.

In another embodiment, the prompting units 107a and 107b can be integrated into a display panel. The antenna positions 103a and 103b can be labeled as the coordinate information which is easy to remember or meets a regular rule (like the label format of “C-X coordinate-Y coordinate”). For example, the C-2-1 is labeled at the antenna position 103a, and the C-3-1 is labeled at the antenna position 103b. When the electronic medicine containing device 101 determines that data read by the antenna at the antenna position 103b from the tag 105b matches with the query message, the information “C-2-1” is prompted on the display panel, so the user can be aware that the objects are placed in the container 109b. In practical implementation, the present disclosure can have the prompting unit and/or coordinate information in a different design, and any manner capable of sending a signal prompting the antenna position when the data read by each antenna from the tag is determined to match with the query message is covered in the scope of the present disclosure.

It is worth mentioning that the electronic medicine containing device 10 illustrated in the embodiment of FIG. 1 has 9 containers, and actually the containers can be designed in different number and the electronic medicine containing device 10 can be designed to have a different shape. The housing 101, container 109a and 109b illustrated in FIG. 1 are just taken as an embodiment, and the electronic medicine containing device 10 of the present disclosure is not limited thereto. The user can selectively label letters on the outer surfaces of the tags 105a and 105b or not, upon the condition of actual use. However, the contents of the containers 109a and 109b had better associate with the tag content of the attached or corresponding tags 105a and 105b, but the containers 109a and 109b are not constrained to be placed corresponding to regular antenna positions 103a and 103b. When placing the contents in the containers 109a and 109b, respectively, the user has to check whether the contents correspond to the tag contents or related tag data of the tags 105a and 105b. After the contents are placed in the containers 109a and/or 109b, the containers 109a and 109b are not limited to be placed back in the original position, a regular position or the position corresponding to the antenna positions 103a and 103b. For example, when placing the container 109b into the housing 101, the user can selectively place the container 109b in the position corresponding to the antenna position 103a. It is worth mentioning that the present disclosure is not limited to placing the containers 109a and 109b in absolute positions inside the housing 101, so long as the contents are ensured to correspond to the tag contents or related tag data. Therefore, the content can be obtained easily by inputting the query message via the query input unit 111 to search the positions of the container 109a or 109b from the multiple containers.

In an embodiment of the present disclosure, the electronic medicine containing device 10 is applied in a medicine container or a medicine cart which is used in the hospital for dispensing medicine and has multiple ill persons' codes. The query input unit 111 provides for the user to input the query data such as an ill person's code or name, and the inputted query data is compared with the data read by each of the antennas from the tags 105a and 105b. The antennas of the electronic medicine containing device 10 are used to read the tag data by turns. When the tag data are read by one of the antennas which matches with the query data, such as the tag data read by the antenna located at the antenna position 103a, the prompting unit 107a sends the prompt signal indicating the antenna position 103a. Therefore, the user can be prompted to infer the position of the container 109a matching with the query data according to antenna position 103a being indicated by the prompt signal, and the corresponding relationship between the container 109a and the tag 105a read by the antenna.

Therefore, while the medical personnel dispenses medicines to an ill person, the electronic medicine containing device 10 of the embodiment of the present disclosure can prevent the ill person's data (such as ill person's name shown on the medicine cart) from being exposed to the public, so as to protect the ill person's privacy. And, the electronic medicine containing device 10 of the embodiment of the present disclosure can prompt the position of the container, so as to achieve the effect of saving medical personnel's time in searching medicine.

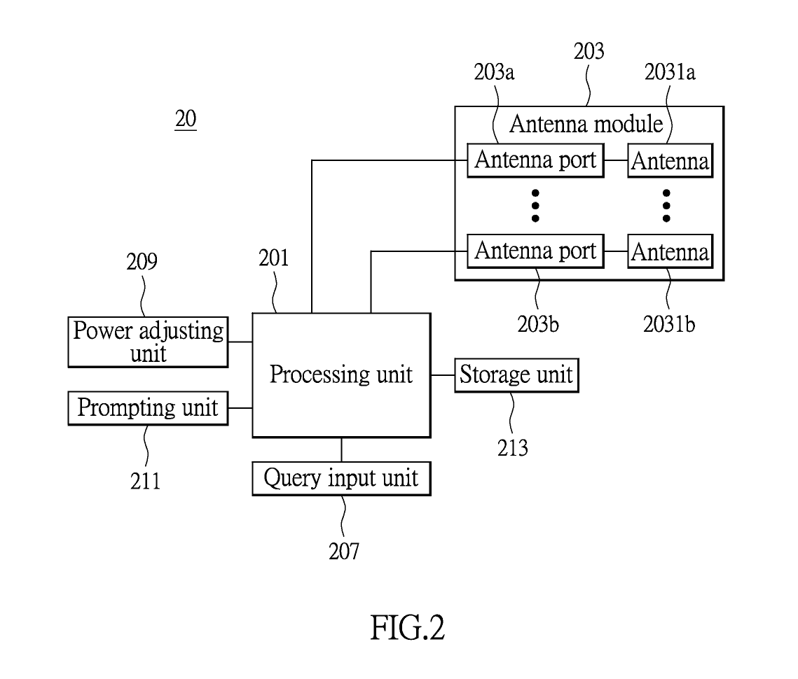

FIG. 2 is a function block view of an embodiment of the electronic medicine containing device according to the present disclosure.

Please refer to FIG. 2, in an embodiment, the electronic medicine containing device 20 includes a processing unit 201 and an antenna module 203. The antenna module 203 includes antenna ports 203a and 203b, antennas 2031a and 2031b. The antenna port 203a is connected to the antenna 2031a and the antenna port 203b is connected to the antenna 2031b. In other embodiment, apart from the processing unit 201 and the antenna module 203, the electronic medicine containing device 20 further includes a query input unit 207, a power adjusting unit 209, a prompting unit 211 and a storage unit 213.

Please refer to FIG. 1 and FIG. 2 both, in this embodiment, the power adjusting unit 209 is configured for adjusting the Rx/Tx power of the antennas 2031a and 2031b. Please refer to FIG. 1 and FIG. 2 both, the antennas 2031a and 2031b are respectively configured on the antenna positions 103a and 103b, to read the corresponding tags 105a and 105b respectively. In other words, the power adjusting unit 209 can set the antenna to different Rx/Tx power upon the practical position of the antenna, to adjust the range in which the antenna can read the tag. In another embodiment, the electronic medicine containing device 10 can be provided with multiple antenna switches (not shown in FIGs) upon demand. Each of the antenna switches can turn on the antenna ready for reading the tag, by turns, so that the electronic medicine containing device 10 can be more flexible in switch control of antennas while the antennas are operated to read the tags.

The storage unit 213 is configured for storing data of each of the tags 105a and 105b, such as identification data and/or tag contents of the tags 105a and 105b. In an embodiment, the identification data are codes of the tags 105a and 105b, and the code can be an ID code of the tag or a management code preset by the user. The tag content is the information associated with the identification data, more particular is the user readable data, such as data of an ill person's name or ill person's medicines, etc. It is worth mentioning that the tag content is the data needed by the manager, and the embodiment of the present disclosure further provides the manager to use the management data as the tag content, so the efficiency of searching data can be improved. For example, after the identification data of the tag 105a is read by the antenna 2031a of the electronic medicine containing device 20, the electronic medicine containing device 20 then provides the tag content corresponding to the identification data to the user.

The query input unit 207 is coupled to the processing unit 201 to provide an interface for inputting letter information or voice information, so the user can input a query message via the query input unit 207. For example, via the query input unit 207 the user can input a key word of the content to be queried or the message related to the tag such as the label letter on the tag. The query input unit 207 includes a display screen and an input keyboard, to provide the corresponding functions of inputting a letter and displaying a query.

The prompting unit 211 is coupled to the processing unit 201 and configured for sending a prompt signal indicating the antenna positions 103a and 103b, such as an indicator, a display panel or an audio output device. Via the prompt signal of the indicative light signal, displayed letter or sound message, the user is noticed the antenna positions 103a and 103b which should be noted, to get the objects in the containers 109a and 109b attached with the tags 105a and 105b.

The processing unit 201 of this example of the electronic medicine containing device 20 is configured for processing the tag data obtained by each of the antenna modules 203. The antenna modules are such as the antennas 2031a and 2031b exemplarily used to read the tag data. The processing unit 201 is also configured for processing the query message of the electronic medicine containing device 20. After receiving the tag data, the processing unit 201 determines whether the tag data matches with the query message input by the user, and then indicates the query result for the electronic medicine containing device according to the query message. For example, when the processing unit 201 determines the data of the tag 105a matching with the query message, the prompting unit 211 of the electronic medicine containing device 20 sends the prompt signal to indicate to the user the corresponding antenna position 103a of the antenna which reads the tag data matching with the query message.

On the other hand, when the processing unit 201 determines that the data of tag 105a is not matching with the query message, the antenna module 203 uses the next antenna to read the next tag. For example, when the processing unit 201 determines the query message input by the user is not matching with the data of the tag 105a read by the current connecting antenna (such as the antenna at the antenna position 103a), the antenna module 203 then reads the data of another tag 105b by another antenna (such as antenna at the antenna position 103b) via another antenna port, and provides the data to the processing unit 201 to further determine whether the tag data read by the antenna 103b matches with the query message. These operations are repeated until the processing unit 201 reads the tag data matching with the query message. It is worth mentioning that the prompting unit sends the signal indicative of no tag data matching with the query message if the processing unit 201 determines no tag data matching with the query message, for example, all indicators emit red light signal, a letter “not found” is shown the display panel, or a voice “not found” is outputted by the audio output device.

It is noted that the antenna module 203 of an embodiment of the present disclosure changes the connected antenna by a manner of switching the antenna ports in proper sequence. In implementation, the user can design the manner of utilizing the antennas by turns according to the practice conditions, for example, a manner of switching to other antenna port based on random possibility, switching to an assigned antenna port based upon an instruction, or switching to another antenna port based upon a history weighting. The above-mentioned manners of utilizing the antennas by turns are taken as examples in the embodiment of the present disclosure, but the manner of switching antennas of the present disclosure is not limited thereto.

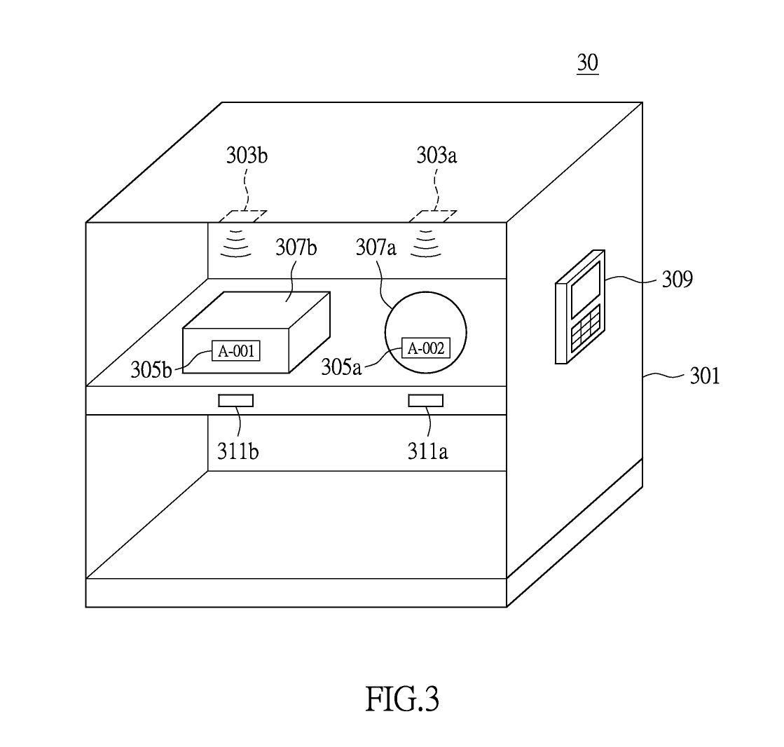

FIG. 3 is a schematic view of other embodiment of the electronic medicine containing device according to the present disclosure.

Please refer to FIG. 3, the electronic medicine containing device 30 is another embodiment provided by the present disclosure. In the FIG. 3, the electronic medicine containing device 30 includes a housing 301, antenna positions 303a and 303b. Containers 307a and 307b are placed on an accommodating frame of the housing 301, and the containers 307a and 307b are attached with tags 305a and 305b, respectively. The user can selectively label letters on surfaces of the tags 305a and 305b, or not label letters, upon the condition of actual use. In another embodiment, the electronic medicine containing device 30 further includes a query prompting unit 309.

It is worth noting that data of the tags 305a and 305b must correspond to the containers 307a and 307b, but the containers 307a and 307b are not limited to correspond to the antenna positions 303a and 303b. For example, while attaching the tags 305a and 305b on the containers 307a and 307b, respectively, the user should check whether the contents of the containers 307a and 307b correspond to the tag content of the tags 305a and 305b. In addition, while the containers 307a and 307b are placed into the housing 301, it is not necessary to limit the positions of the containers 307a and 307b in the housing 301 to the specific positions, the regular positions or the positions corresponding to the antenna positions 303a and 303b. For example, while placing the container 307b into the housing 301, the user can selectively place the container 307b at the position corresponding to the antenna position 303a, but not antenna position 303b. That is, the electronic medicine containing device 30 of an embodiment of the present disclosure allows the user just to notice whether the data of the tags correspond to the contents of the containers 307a and 307b, and it is not needed to spend extra attention on placing the containers 307a and 307b at the correct positions in the housing 301.

The query prompting unit 309 includes a prompting unit and a query input unit. Please refer to FIG. 1 and FIG. 3 both, in the electronic medicine containing device of the present disclosure, the prompting units 107a and 107b and the query input unit 111 of the electronic medicine containing device 10 are integrated into the query prompting unit 309. The query prompting unit 309 can provide the above-mentioned functions of the prompting units 107a and 107b and query input unit 111, so the detailed description is omitted. The query prompting unit 309, such as an electronic device having a display screen, an input unit and a processor, can provide the user the functions of inputting the query message and outputting the query result.

On the other hand, please refer to FIG. 3, the electronic medicine containing device 30 can further selectively be provided with display units 311a and 311b disposed on the accommodating frame of the housing 301, for displaying data related to the objects. For example, when the user wants to get the detailed data of the content in the container 307a, the reader at the antenna positions 303a or 303b can be used to directly get the data of the tag on the container 307 and then the detailed data of the content in the container 307a is displayed on the display unit 311a or the display unit 311b. It is worth mentioning that the embodiment the present disclosure is for illustrating the functions of the display units 311a and 311b, but is not limited to the number of the display units 311a and 311b. For example, the user can design a ratio between the numbers of the antennas and the readers, and the corresponding positions of the readers and the display units upon practical conditions. Any design based on the same principle is covered in the scope of the electronic medicine containing device 30 of the present disclosure.

Please refer to FIG. 1 and FIG. 3 both. The housing 301 of the electronic medicine containing device 30 is served as an accommodating frame or an accommodating cabinet to allow the user to get objects conveniently, compared with the electronic medicine containing device 10 of FIG. 1, in which the objects are accommodated in the containing boxes. The tag contents of the tags 105a and 105b of the electronic medicine containing device 10 of the present disclosure correspond to the containers 109a and 109b, and the tag content of tags 305a and 305b of the electronic medicine containing device 30 correspond to the contents of the containers 307a and 307b. However, the embodiment of the present disclosure is not constrained to the positions of the containers 109a and 109b being placed in the housing 101, or the positions of the containers 307a and 307b being placed in the housing 301.

It is worth noting that in the electronic medicine containing devices 10 and 30 provided in the present disclosure the tags are attached on the containers and correspond to the real physical positions. However, when the processing module compares the query message inputted by the user with each of the tag data, the position indicated by the prompt signal is for the container where the content matching with the query message is placed, but not for the container associated with the tag. Therefore, the electronic medicine containing device of the embodiment of the present disclosure provides the user the technical effect of flexibly placing and getting the content by limiting the corresponding relationship between the tag and content of container, but without limiting the position of the container in the housing, and without limiting the corresponding relationship the tag and the container.

Therefore, when the user places objects, the embodiment of the present disclosure can allow the user to focus attention on ensuring whether the objects accommodated in the containers 109a and 109b match with the tag content of the tag attached on the containers 109a and 109b, and ensuring whether the contents of the containers 307a and 307b match with the tags attached on the containers 307a and 307b. For example, the pharmacist can focus on checking whether an ill person's medicines are correct, and need not spend time on checking whether the positions of the containers 109a and 109b are correct, and need not spent time on checking whether the positions of the containers 307a and 307b are correct, so as to improve the efficiency of managing and dispensing objects for the user.

### Second Embodiment of Electronic Medicine Containing Device

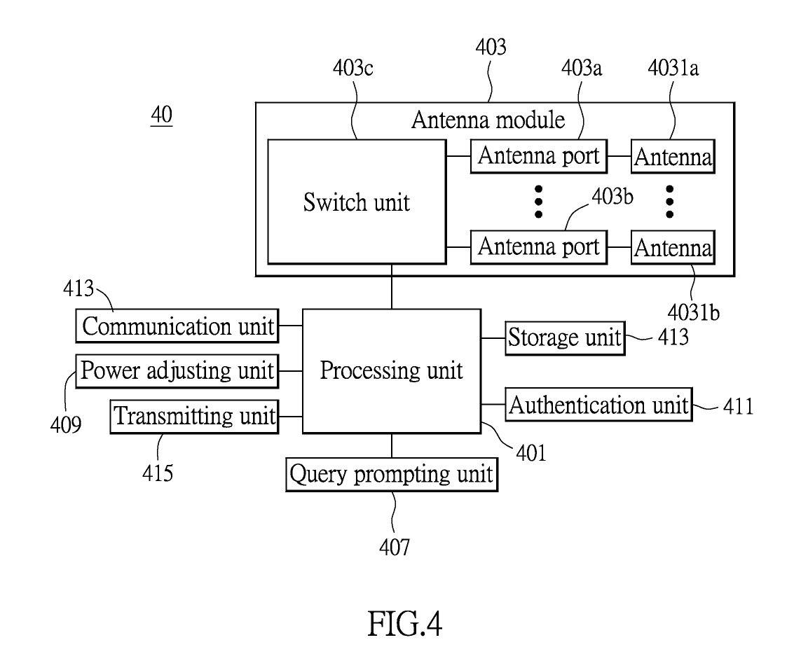

FIG. 4 is a function block view of an embodiment of the electronic medicine containing device according to the present disclosure.

Please refer to FIG. 4, the electronic medicine containing device 40 includes a processing unit 401, an antenna module 403, a query prompting unit 407, a power adjusting unit 409, an authentication unit 411, a communication unit 413 and a transmitting unit 415. The antenna module 403 is coupled to the processing unit 401 and includes a switch unit 403c, antenna ports 403a and 403b, and antennas 4031a and 4031b. The antenna port 403a is connected to the antenna 4031a, and the antenna port 403b is connected to the antenna 4031b.

The switch unit 403c is coupled to the processing unit 401, and antenna ports 403a and 403c. The switch unit 403c can perform a switch control between the antenna ports 403a and 403b. For example, the switch unit 403c is a circuit switch. When the switch unit 403c performs switching between the antenna ports 403a and 403b, for example, switching to the antenna port 403a, the antenna 4031a corresponding to the antenna port 403a is then electrically connected to the switch unit 403c. At this time, the antenna 4031a electrically connected to the switch unit 403c reads the corresponding tag, so that the switch unit 403c can provide the tag data to the processing unit 401.

Please refer to FIG. 2 and FIG. 4, the electronic medicine containing device 40 further includes a query prompting unit 407, an authentication unit 411, a communication unit 413 and a transmitting unit 415. The query input unit 207 and the prompting unit 211 are integrated into the query prompting unit 407, and the query prompting unit 407 provides an interface of inputting letter information or voice information to allow the user to input query message and send the prompt signal prompting the position of the antenna.

Please refer to FIG. 4. The authentication unit 411 is configured for determining whether the user's ID data matches with an authentication data. Preferably, the authentication unit 411 can be a physiological feature recognition unit or chip read unit. Next, when the authentication unit 411 determines that the user's ID data match with the authentication data, a protection lock device (not shown in FIGs) of the electronic medicine containing device 40 executes a corresponding unlocking action, such as unlocking the container 109a and/or container 109b of the FIG. 1, or the housing 101, whereby the nursing person can get the ill person's medicines within the container.

The communication unit 413 is configured for exchanging data with a data server at a remote end. Preferably, the communication unit 413 can be a wired communication unit or a wireless communication unit. For example, the electronic medicine containing device 40 gets data from the data server via the communication unit 413, to update or synchronize the content of the storage unit 413.

The transmitting unit 415 provides an interface connected to a computer device (not shown in FIGs). Preferably, the transmitting unit 415 can be a Universal Asynchronous Receiver/Transmitter (UART). In an embodiment, the processing unit 401 transmits the tag data gotten by each of the antennas to the computer device via the transmitting unit 415, to enable the computer device to analyze data or backup; or, the computer device can transmit a control instruction via the transmitting unit 415 to the electronic medicine containing device 40 for setting. It is worth mentioning that the electronic medicine containing device 40 of the present disclosure can be provided with no query prompting unit 407, but can use the computer device connected with the transmitting unit 415 to provide the query function and display function of the query prompting unit 407.

### An Embodiment of System for Dispensing Medicines

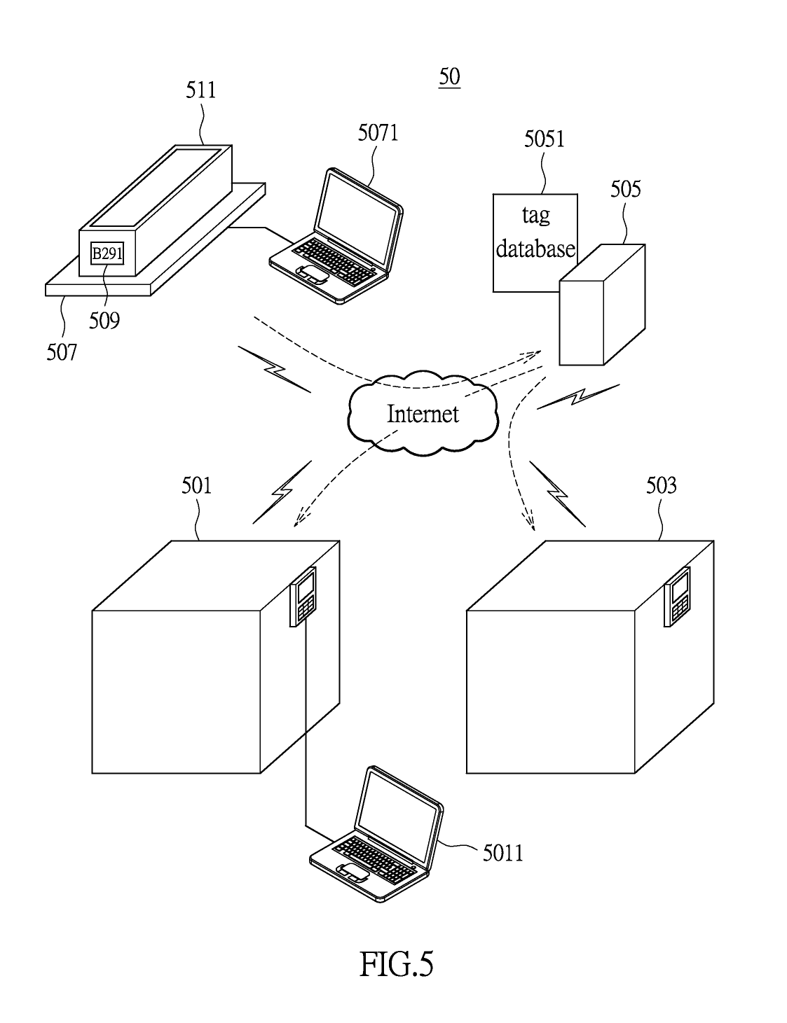

FIG. 5 is a schematic view of a system environment of an embodiment of a system for dispensing medicines according to the present disclosure.

Please refer to FIG. 5, the system for dispensing medicines 50 includes an electronic medicine containing devices 501 and 503, and a data server 505. The electronic medicine containing devices 501 and 503 are linked with the data server 505, and exchange data with each other in local area network or a global area network via wired or wireless network connection.

In this example, the tag 509 includes ID data such as the hardware identification code of the tag chip. The ID data of the tag 509 can be read by the login device 507. The login device 507 can be a wireless RFID chip reader and writer, or a NFC chip reader and writer. The login device 507 can establish a wireless communication connection or NFC connection with the tag 509, to get the ID data of the tag. In this example, the login device 507 further writes the identification data into the tag 509 upon practical demand, for example, the ill person's code or objects code can be inputted into the tag 509 via a computer device 5071. In another embodiment, the login device 507 is linked with the data server 505 via the Internet, and writes the related data of the tag in the data server 505. The login device 507 provides for the user to enter the tag content associated with the tag 509 in the data server 505, for example, the medical record data or objects data associated with the ill person code is inputted via the computer device 5071. The user can use the login device 507 to input related data of the tag 509 at different locations, to enable the electronic medicine containing device 501s and 503 at the same position or different positions to provide the subsequent functional operations. The detailed process is described in the following paragraph.

### An Embodiment of the System for Dispensing Medicines

In an example of the system for dispensing medicines 50 of the present disclosure, the login device 507 can provide the pharmacist with a medicine preparing procedure. When preparing medicines, the pharmacist can write the identification data into the tag 509 upon practical conditions, the identification data can be a letter the same as the labeled letter “B291”. Next, the pharmacist prepares medicines according to a prescription or a recipe, and places the medicines for the ill person into the container 511, and then writes the tag content of the tag 509 such as the data of an ill person's name or recipe in the tag database 5051. In partial conditions, the login device 507 can continue to use the original identification data without changing the identification data. For example, when the ill person changes the recipe, the pharmacist just changes the tag content of the tag 509 recorded in the tag database 5051 while preparing the medicines, and then places the medicine into the container 511 according to the recipe without changing the identification data of the tag 509.

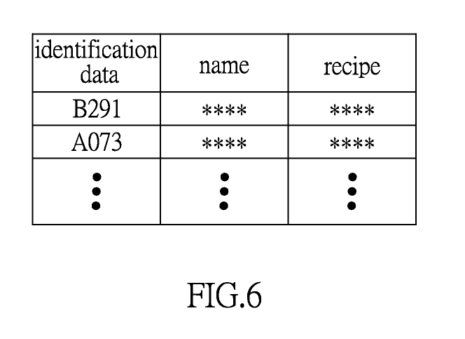

FIG. 6 is a schematic view of content of a tag database of an embodiment according to the present disclosure. Please refer to FIG. 5 and FIG. 6 both. When the pharmacist completes preparing medicines, the data recorded in the tag database 5051 include the identification data “B209” and related messages such as the ill person's name and recipe.

In another example of the system for dispensing medicines 50 of the present disclosure, the data server 505 is linked with the doctor's outpatient clinic system, for example, the data server 50 can obtain medical record data such as the ill person's name and recipe, and generate a column for the pharmacist to fill the identification data of the tag, and the identification data indicates the pickup code for the ill person. Therefore, while preparing medicines, the pharmacist can review tag database 5051 to prepare medicines in the containers 511 one by one, for example, the pharmacist places the medicines in the containers 509 according to the recipe content recorded in the tag database 5051, and then fills the identification data (such as “B291” shown in FIG. 5) of the tag of the container 509 the medicine is placed into, in the identification data column corresponding to the recipe in the tag database 5051. Therefore, the medicines preparing management flow is completed. The pharmacist can arbitrarily select the container on the medicine cart while preparing medicines, so the pharmacist need not spent time on whether the container selected to place the ill person's medicine is wrong.

Please refer to FIG. 1, FIG. 5 and FIG. 6. After preparing the medicines according to the recipe corresponding to the tag 509 (i.e. the tag with identification data “B291”), the pharmacist can place the container 511 at any position within the housing 101. Therefore, the pharmacist needs not check whether or not the containers on the medicine cart are placed at the wrong positions. For example, the container 511 can be placed at the position of the container 109a, or be placed at the position of the container 109b. That is, each of the containers in the electronic medicine containing device 10 of the present disclosure is not constrained to an absolute position. For example, the tag 105a is not constrained to be placed at the position shown in FIG. 1, but the pharmacist can also exchange the positions of the containers 109a and 109b. This embodiment provides the pharmacist with a way to prepare a batch of medicines, and need not process extra paperwork or pay attention to placing the container 511 at the regular position. Therefore, the pharmacist can focus on preparing medicine, and the condition that the ill person receives wrong medicines can be reduced.

Please refer to both FIG. 1 and FIG. 5. In an example of the system for dispensing medicines 50 of the present disclosure, when the pharmacist prepares medicines into the all containers in the electronic medicine containing device 10, these medicines are dispensed to ill persons one by one, by the medical personnel. For example, the medical personnel reviews the identification data “C307” on the medical record on the sickbed, and then inputs “C307” in the query input unit 111. The electronic medicine containing device 10 further reads the tag 105b by the antenna, and upon a comparison result determines the data of the tag 105b matching with the query message, and the prompting unit 107b sends the prompt signal correspondingly. Therefore, the medical personnel can dispense medicines within the container 109b to the ill person. During the process of the electronic medicine containing device 10 searching the query message, each of the antennas is operated to read the tags located within its readable range, by turns. When the tag data read by the antenna does not match with the query message, the next antenna is operated to read the corresponding tag. On the other hand, the computer device 5011 connected to the electronic medicine containing device can provide the maintenance personnel or the engineering personnel to configure data or directly get data.

Apart from simplifying the procedure of the pharmacist dispense medicines from the containers, in the system for dispensing medicines provided by the present disclosure, the pharmacist can focus attention on the process of preparing medicines to increase correctness of dispensed medicines, and the time of medical personnel searching medicine while dispensing medicines to the ill person end can be shortened, and an ill person's data privacy can be improved without impairing the efficiency of dispensing medicines. Therefore, the integration and efficiency improvement at the medicine preparing end and the medicine dispensing end both can be achieved.

### Embodiment of Method for Dispensing Medicine

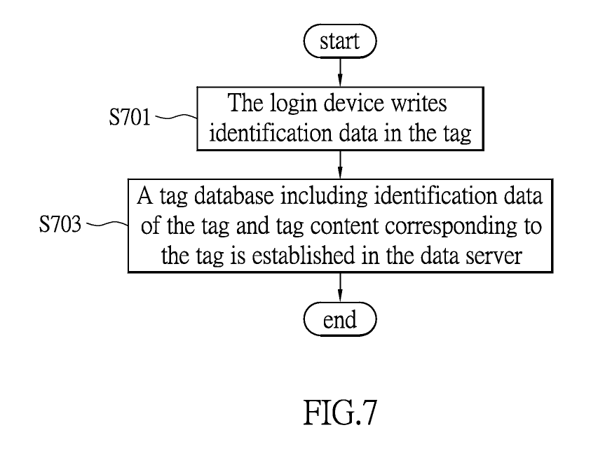

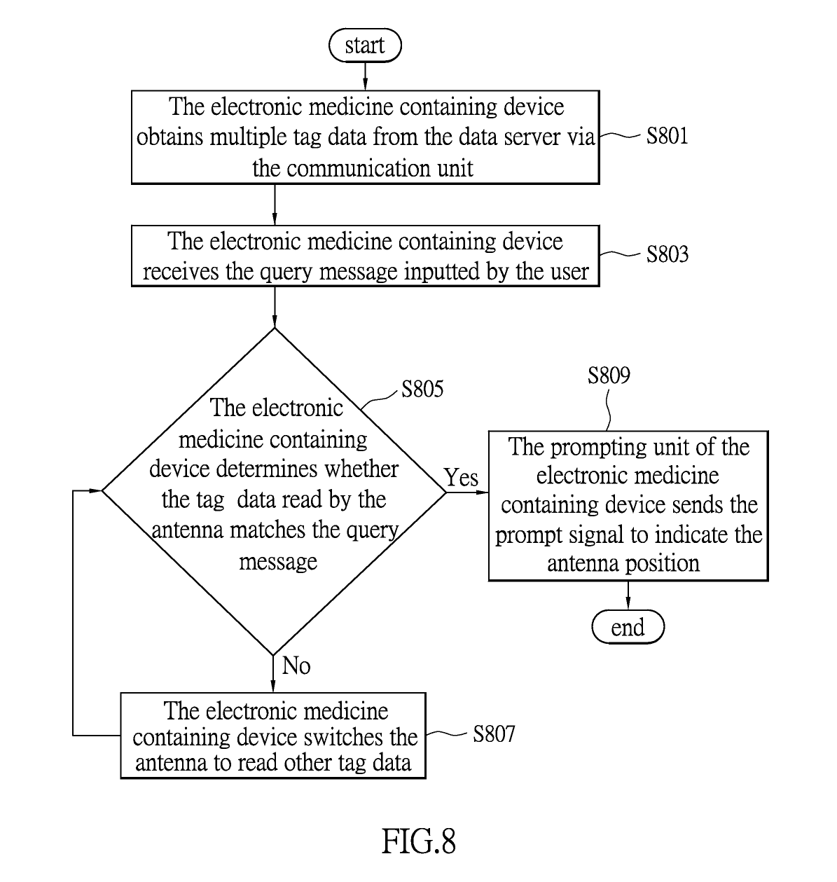

FIG. 7 and FIG. 8 are flow views of an embodiment of a method of dispensing medicine according to the present disclosure.

The method for dispensing medicine of the present disclosure includes a write-in procedure and a read procedure, and is adapted for the aforementioned system for dispensing medicines. Please refer to FIG. 7 which illustrates the write-in procedure of the method for dispensing medicine of the present disclosure. In step S701, the login device writes identification data in the tag, as an initialize procedure for the tag. In an embodiment, the written identification data is a code for the ill person or other management procedure. Next, in step S703, a tag database including identification data of the tag and tag content corresponding to the tag is established in the data server. In an embodiment, the tag content corresponding to the tag is an ill person's name and/or recipe data.

Please refer to FIG. 8 which illustrates a read procedure of the method for dispensing medicine of the present disclosure. In step S801, the electronic medicine containing device obtains multiple tag data from the data server via the communication unit, to update the tag data in the storage unit of the electronic medicine containing device. Next, in step S803, the electronic medicine containing device receives the query message inputted by the user. Next, in step S805, the electronic medicine containing device determines whether the tag data read by the antenna matches the query message. If yes, the step S809 is proceeded; if no, step S807 is proceeded. In step S807, the electronic medicine containing device determines the tag data read by the antenna is not matching with the query message, the electronic medicine containing device switches the antenna to read other tag data, and returns to proceed step S805 for determination. In step S809, the electronic medicine containing device determines the tag data read by the antenna is matching with the query message, the prompting unit of the electronic medicine containing device sends the prompt signal to indicate the antenna position, so the user can obtain the position of the container corresponding to the tag according to the indication of the prompting unit. In another example, when determining the tag data read by the antenna matching the query message, the electronic medicine containing device unlocks the container, for example, the container is unlocked and ejected by a protection lock device.

Based upon practical condition, the electronic medicine containing device provided by the embodiment of the present disclosure can have different settings for switching an antenna when the tag data read by the antenna is determined to not match with the query message, for example, the electronic medicine containing device can switch antennas in proper sequence, switch antennas according to random possibility, switch to an assigned antenna based upon an instruction, or switch to another antenna based upon history weighting. Any manner of switching antenna can be applied in the present disclosure, and the present disclosure is not limited to the above-mentioned switching manner.

To sum up, the electronic medicine containing device, system for dispensing medicines and method thereof provided in the embodiment of the present disclosure can be applied in a medical institution to prepare and dispense a batch of medicines, and provide the integration of the medicine preparing end and medicine dispensing end. Apart from simplifying the procedure of the pharmacist preparing medicines, the pharmacist can further focus attention on the process of preparing medicines to increase accuracy for the ill person obtaining medicines, and improve security of medicines, and the time of medical personnel searching medicine while dispensing medicine to the ill person can be shortened, and data privacy of the ill person can be improved without impairing the efficiency of dispensing medicine. Therefore, the hospital management flow can be met, and the integration and efficiency improvement at a medicine preparing end and a medicine dispensing end both can be achieved.

The above-mentioned descriptions represent merely the exemplary embodiment of the present disclosure, without any intention to limit the scope of the present disclosure thereto. Various equivalent changes, alterations or modifications based on the claims of the present disclosure are all consequently viewed as being embraced by the scope of the present disclosure.

What is claimed is:

1. An electronic medicine containing device, comprising:
a housing, configured for placing one or more containers;
an antenna module, comprising multiple antenna ports, each of the antenna ports coupled to one of multiple antennas, and each of multiple antennas configured on an antenna position in the housing, and each of the multiple antennas configured for reading a tag placed in the container;
a processing unit, coupled to the antenna module, configured for receiving the tag data gotten by the antenna module and processing a query message of the electronic medicine containing device; and
a prompting unit, coupled to the processing unit, configured for showing a result generated by the electronic medicine containing device based on the query message.

2. The electronic medicine containing device according to claim 1, wherein the data read by the antenna comprise one selected from an identification data and a tag content of the tag.

3. The electronic medicine containing device according to claim 2, wherein the antenna module further comprises a switch unit which is coupled to the multiple antenna ports and the processing unit, and the electronic medicine containing device further comprises:
a query input unit, coupled to the processing unit, configured for receiving the query message;
wherein, when the processing unit determines at least one of the identification data and the tag content matching with the query message, the prompting unit sends a prompt signal indicating the antenna position; and when the processing unit determines the identification data and the tag content both are not matching with the query message, the switch unit switches the multiple antenna ports to read other tag data via another antenna.

4. The electronic medicine containing device according to claim 3, wherein the prompting unit comprises at least one of multiple indicators configured at positions correspondingly to the antenna positions, a display panel, and an audio output device, wherein the query input unit and the prompting unit are integrated in a query prompting unit.

5. The electronic medicine containing device according to claim 2, wherein the prompting unit indicating the query result further generates a prompt signal indicating the antenna position and gets the position of the container based on the corresponding relationship between the antenna positions and the tags in the container.

6. The electronic medicine containing device according to claim 5, further comprising:
a power adjusting unit, configured for setting Rx/Tx power of the multiple antennas; and
a storage unit, configured for storing the tag content corresponding to the identification data of the tag;
wherein, each of the multiple antennas has a readable range according to the Rx/Tx power, and reads the corresponding tag; after the antenna reads the identification data of the tag, the processing module accesses the storage unit according to the identification data so as to obtain the tag content corresponding to the tag.

7. The electronic medicine containing device according to claim 6, further comprising:
an authentication unit;
a communication unit, configured for exchanging data with a data server; and
a transmitting unit, linked with a computer device;
wherein when the authentication unit determines an ID data of a user to be valid, a protection lock device of the electronic medicine containing device unlocks the housing.

8. The electronic medicine containing device according to claim 7, wherein the housing is an accommodating frame or a containing case.

9. The electronic medicine containing device according to claim 7, wherein the electronic medicine containing device is a medicine container having multiple ill person codes.

10. A system for dispensing medicines, comprising:
a data server;
at least one electronic medicine containing device, each of the at least one electronic medicine containing devices linked with the data server via a communication unit, and comprising:
a housing, configured for placing one or more container;
an antenna module, comprising multiple antenna ports, each of the antenna ports coupled to one of multiple antennas, and each of multiple antennas configured on an antenna position in the housing, and configured for reading the tag placed in the container;
a processing unit, coupled to the antenna module, configured for receiving the tag data gotten by the antenna module and processing a query message of the electronic medicine containing device; and
a prompting unit, coupled to the processing unit, configured for showing a result generated by the electronic medicine containing device based on the query message.

11. The system for dispensing medicines according to claim 10, wherein the data server establishes a tag database according to an input data of the tag written by a login device, and the input data of the tag database comprises at least one of an identification data and a tag content of the tag.

12. The system for dispensing medicines according to claim 11, wherein the antenna module further comprises a switch unit which is coupled to the multiple antenna ports and the processing unit, and the electronic medicine containing device further comprises a storage unit, and the electronic medicine containing device updates the identification data and the tag content of the tag stored in the storage unit by the tag database of the data server;
wherein, when the processing unit determines at least one of the identification data and the tag content matches with the query message, the prompting unit sends the prompt signal indicating the antenna position; and
when the processing unit determines both the identification data and the tag content fail to match with the query message, the switch unit switches the multiple antenna ports to read other tag data via another antenna.

13. The system for dispensing medicines according to claim 11, wherein the tag content is at least one of the ill person's name and recipe.

14. A method for dispensing medicine, adapted for a system for dispensing medicines, the system for dispensing medicines comprising a data server and at least one electronic medicine containing device, the method for dispensing medicine comprising a write-in procedure and a read procedure, the read procedure comprising:
getting multiple tag data from the data server via a communication unit of the electronic medicine containing device; and
comparing a query message with a tag data read by an antenna of the electronic medicine containing device;
wherein when the tag data matches with the query message, a prompting unit of the electronic medicine containing device sends a prompt signal to indicate an antenna position of the antenna.

15. The method for dispensing medicine according to claim 14, wherein the read procedure further comprises:
when the tag data does not match with the query message, a switch unit of the electronic medicine containing device switches to another antenna from the multiple antennas to read other tag data correspondingly.

16. The method for dispensing medicine according to claim 15, wherein the write-in procedure comprises:
in the data server, establishing a tag database based on an input data written by a login device for the tag.

17. The method for dispensing medicine according to claim 16, wherein the data tag comprises at least one of an identification data and tag content.

18. The method for dispensing medicine according to claim 14, wherein when the tag data matches with the query message, a protection lock device of the electronic medicine containing device further unlocks a housing of the electronic medicine containing device.

19. The method for dispensing medicine according to claim 15, wherein the switching to another antenna among multiple antennas by the switch unit comprises switching in sequence, switching in random, switching according to instruction or switching according to weighting.
